(19) United States
(12) Patent Application Publication
(10) Pub. No.: US 2021/0152383 A1
(43) Pub. Date: May 20, 2021

(54) DELIVERING CONTENT IN MULTIPLE AREAS USING HIERARCHICAL AREA IDENTIFIERS

(71) Applicant: Telefonaktiebolaget LM Ericsson (publ), Stockholm (SE)

(72) Inventors: Haogang XU, Täby (SE); Jie LING, Shanghai (CN); Wenhu TANG, Stockholm (SE); Jinyang XIE, Shanghai (CN)

(21) Appl. No.: 17/045,131

(22) PCT Filed: Feb. 27, 2019
(86) PCT No.: PCT/EP2019/054810

§ 371 Date: Oct. 2, 2020

(30) Foreign Application Priority Data
Apr. 6, 2018 (CN) PCT/CN2018/082084

(51) Int. Cl. H04L 12/18; H04W 4/06; H04L 29/06

(52) U.S. Cl. CPC H04L 12/1845; H04L 65/4076; H04L 12/189; H04W 4/06

(57) ABSTRACT

A method for delivering content. In some embodiments, the method includes a network node adding a first area identifier, AI, to a set of AIs and, after adding the first AI to the set of AIs, determining that an optimized set of AIs should be created. The network node then performs a process for producing the optimized set of AIs, where the process includes: removing from the set of AIs a certain subset of AIs and adding to the set of AIs a second AI. The network node transmits to a second network node a message comprising information identifying each AI included in the optimized set of AIs.

### TECHNICAL FIELD

Disclosed are embodiments related to the delivery of content (e.g., the delivery of media content (e.g., a video stream) or other content via an MBMS broadcast) in multiple areas using hierarchical area identifies (e.g., hierarchically structured MBMS Service Area Identities (SAIs)).

### BACKGROUND

MBMS (Multimedia Broadcast Multicast Services) and eMBMS (evolved MBMS) are broadcasting services. eMBMS is offered via an Evolved Packet Systems (EPS) including Evolved Universal Terrestrial Radio Access Network (E-UTRAN) (LTE) and UTRAN access. Typical use cases include: (1) delivery of media content (e.g., live video content) to user equipments (UEs) in highly gathered areas (e.g., in stadium or arena) (as used herein a UE is a device capable of wireless communication with an a base station or other access point); (2) delivery of popular on-demand files (e.g., an Android update, a viral video clip, etc.); and (3) delivery of group communication application data (e.g., Mission Critical Push To Talk (MCPTT), MC Push to Data and MC Push to File); eMBMS system can use the Group Communication delivery method to transfer data from one or multiple Group Communication systems application server (AS) sessions via a single MBMS bearer.

A Broadcast Multicast Service Center (BM-SC) is a network node that controls the general flow of content from content providers to UEs, including providing both content and metadata at appropriate points in time. A BM-SC uses the “SGi” interface to communicate with a PDN Gateway for the communication with a UE through unicast, like service announcement distribution through unicast, receiving consumption report from UE.

An MBMS Gateway (MBMS-GW) is a network node that connects the BM-SC with an access network (e.g., E-UTRAN). The MBMS-GW is also responsible for session management and communicates with a Mobility Management Entity (MME), which is a core network node for the E-UTRAN. The function of the MBMS GW is to deliver MBMS packets to the E-UTRAN for relay to UEs. The MBMS-GW performs MBMS Session Control Signaling towards E-UTRAN, via the MME.

MBMS Operation on Demand (MOOD)

The Third Generation Partnership Project (3GPP) has defined “MBMS operation on Demand (MooD) (see 3GPP TS 26.346 release 12). MooD is about enabling the setup of an MBMS user service on the fly and seamlessly migrating an existing service to an MBMS user service, about judging a unicast service to see if it would be better served by broadcast or unicast, and about enabling an MBMS Broadcast Session for an ongoing MBMS User Service where previously there was none active

For example, via MooD, in order to efficiently use network resources certain content that is initially delivered via unicast may be turned into an MBMS User Service when the unicast traffic volume exceeds a certain threshold. Such dynamic conversion from unicast delivery to MBMS delivery is referred to as “MBMS offloading.” It is also possible to stop MBMS delivery when the number of UEs consuming the certain content falls lower than a threshold. The UEs that are still interested in receiving the content may switch the consumption from MBMS delivery towards unicast delivery.

There are two options for implementing MooD. The first option is Consumption report based MooD. Under this option, UEs send consumption reports towards BM-SC for the service consumption together with their location information. Based on the consumption reports, BM-SC may dynamically start or stop MBMS delivery for the service. The second option is Proxy based MooD. Under this option, UEs send HTTP/RTSP requests towards a pre-configured MooD proxy server. The MooD proxy server determines whether or not to start the MBMS delivery for a certain service based on the UE location information. Once the MBMS delivery is started, the MooD proxy server redirect the reception to MBMS in the HTTP/RTSP response. The proxy based MooD solution is more efficient without introducing the addition consumption report traffic. But it can only provide means to start MBMS delivery (i.e. enable UE to switch from unicast delivery to MBMS delivery). It cannot provide an effective way to stop MBMS delivery based on the UE consumption situation.

The consumption report based MooD solution is able to measure the accurate information about the MooD switching, including both start MBMS delivery and stop MBMS delivery, due to the reason that UE provides the accurate consumption information together with its location information in the consumption report.

For example, under the consumption report based MooD solution, the BM-SC keeps a count of the total number of UEs that are consuming certain content via a unicast delivery. When the unicast load exceeds a certain threshold (upper switch threshold), the BM-SC triggers the MBMS delivery of the certain content. Similarly, the BM-SC keeps a count of the total number of UEs that are consuming certain content via MBMS delivery. When the MBMS load falls below a certain threshold (lower switch threshold), the BM-SC stops the MBMS delivery of the certain content.

The starting or the stopping of MBMS delivery is triggered on per service area basis. When the BM-SC decides to start (or update) MBMS delivery, the BM-SC transmits a start (or update) request message that includes a Service Area Identifier (SAI) list (e.g., a list of N service area codes where each service area code in the list represents the coding for an MBMS SAI).

Like the above described 3GPP defined MooD, an application server (e.g. GCSE —Group Communication System Enablers—Application Server) can also implement a similar function as BM-SC in order to dynamically activate or deactivate a broadcast session in certain areas based on received consumption reports from clients (e.g., GCAS clients).

Service Area Identities (SAI)

The MBMS Service Area and Service Area Identities (SAIs) are discussed in 3GPP TS 23.003. The MBMS Service Area comprises of one or more MBMS Service Area Identities (MBMS SAIs). An MBMS SA shall not include more than 256 MBMS SAIs. An MBMS SAI shall identify a group of one or more cells within a Public Land Mobile Network (PLMN) that is independent of the associated Location/Routing/Service Area and the physical location of the cell(s). A cell shall be able to belong to one or more MBMS SAs, and therefore is addressable by one or more MBMS SAIs. The MBMS SAI is a decimal number between 0 and 65,535 (inclusive). The value 0 has a special meaning; it shall denote the whole PLMN as the MBMS Service Area and it shall indicate to a receiving RNC/BSS/MCE that all cells reachable by that RNC/BSS/MCE shall be part of the MBMS Service Area. With the exception of the specific MBMS Service Area Identity with value 0, the MBMS Service Area Identity shall be unique within a PLMN and shall be defined in such a way that all the corresponding cells are MBMS capable.

### SUMMARY

The above mentioned MBMS session start request message (and session update request message) includes an MBMS-Service-Area attribute-value-pair (AVP), which is defined in TS 29.061 at section 17.7.6. As explained in TS 29.061, the MBMS-Service-Area AVP consists of two parts: a first part that specifies the number N of MBMS service area codes that are included in the MBMS-Service-Area AVP and a second part that contains N MBMS service area codes. The first part is one octet in length, which means that N must be less than or equal to 256. Each MBMS service area code represents the coding for the MBMS SAI. Accordingly, the start request message (and update message) can indicate not more than 256 SAIs.

For a non-MooD broadcast service, an MBMS service operator can choose the SAIs for the target broadcast area carefully to ensure the number of SAIs shall not exceed 256. But because the MooD broadcast service is dynamic, the SAIs cannot be determined in advance.

For MooD service, the MBMS service operator would desire to define a certain geography coverage granularity of SAIs, as MBMS service is going to be triggered per SAI. A broadcast of certain content will only be efficient when the number of interested UEs within a specific SAI reach a threshold (an “interested” UE is a UE that is consuming (or preparing to consume) the certain content), and the larger area require more interested UEs to reach the threshold.

A MooD service normally requires use of SAIs that cover a small area (e.g., 30 cells). If the service area coverage is too large, then there is less likelihood that the number of interested UEs will exceed the threshold, and this will not help off-load the traffic in congested small areas. For example, a BM-SC can switch the delivery of certain content from unicast to broadcast for a hot spot serving 30 cells when there are more than 60 UEs consuming the content in the area defined by the SAI, i.e. 2 UEs per cell. But for a larger area that encompasses 100 cells, it will require 200 interested UEs in the larger area. Accordingly, in a scenario in which an SAI identifies 100 cells and the threshold is 60 interested UEs, then it is possible that the threshold will not be reached, but nevertheless several hot spots within the SAI are congested (e.g., have more than two interested UEs).

In order to have a more efficient and effective MooD operation, the SAI used by MooD need to be designed small enough to catch those scenarios where popular contents consumption are concentrated in a few hot spot areas. It is quite common that one SAI is designed to cover for maximum 30-50 cells, a national MooD broadcast may require thousands of SAIs to be involved. With the maximum 256 SAI limitation, BM-SC will not be able to activate broadcast for all these hot spot areas, if the number of these areas are larger than 256.

One possible solution is to broadcast the content in 256 SAIs, and let the other service areas to be served via unicast. The drawback of this limitation is that the unicast areas are prone to traffic congestion, which may result in bad user experience for the UEs in those unicast areas. Another possible solution is to exceed the limitation of the number of service areas. That is, to update MBMS-Service-Area AVP to include 4096 or even 65536 SAIs, so that BM-SC can carry much more SAIs in session start request or session update request. Accordingly, the similar action needs to be taken in Sm interface to allow MBMS-GW to pass those SAIs to the MME. This solution however will require large message sizes due to the large SAI list, and the nodes that process the list will need to much longer handling time to process the lists.

A better solution, which is described herein, is to utilize hierarchically structured area identifiers (e.g., SAIs or other area identifiers). With hierarchically structured AIs, a network node (e.g., a BM-SC, application, or other network node) can start off using up to a threshold number of small area AIs (e.g., AIs that identify less than 50 cells) and then as further areas need to be added to the service area the network node can replace a group of small area AIs with a large area AI that “encompasses” or “includes” each one of the small AIs included in the group such that the total number of AIs stays below the threshold. A first AI “encompasses” or “includes” a second AI when each of the areas (e.g., each cell) identified by the second AI is an area (e.g., cell) identified by the first AI. For example, if the first AI identifies the followings cells: cell A, cell B, cell C and cell D; and the second AI identifies cell A and cell D, then the first AI encompasses (or includes) the second AI.

Accordingly, in one aspect there is provided a method for delivering content (e.g., delivering content via MBMS), wherein the method is performed by a first network node (e.g., a BM-SC). In some embodiments, the method includes the first network node adding a first AI (e.g., an MBMS Service Area Identifier (SAI)) to a set of AIs. The method further includes, after adding the first AI to the set of AIs, the first network node determining that an optimized set of AIs should be created (e.g., the first network node determines that the number of AIs included in the set of AIs exceeds a threshold (e.g., 256)). The method also includes the first network node performing a process for producing the optimized set of AIs, where process includes: removing from the set of AIs a certain subset of AIs (e.g., a group of local AIs) and adding to the set of AIs a second AI (e.g., a non-local AI), the second AI identifying a set of cells (e.g., the second AI is used to identify a set of one or more access points, each of which serves one or more cells), wherein each one of the AIs included in the certain subset of AIs removed from the set of AIs identifies a subset of the cells included in the set of cells identified by the second AI (i.e., the second AI encompasses each one of the AIs included in the certain subset). The method also includes the first network node transmitting to a second network node (e.g., MBMS-GW) a message (e.g., a session start message or a session update message) comprising information identifying each AI included in the optimized set of AIs (e.g., a message comprising a list of MBMS service area codes).

In some embodiments, determining that an optimized set of AIs should be created comprises the first network node determining whether N is greater than T, wherein N is the number of AIs included in the set of AIs and T is a predetermined threshold.

In some embodiments, the method also includes, prior to adding the first AI to the set of AIs: the first network node determining the total number of user equipments, UEs, that are i) being served by a cell identified by the first AI and ii) consuming or preparing to consume a certain item of content; the first network node determining whether the determined total number of UEs exceeds a threshold; and the first network node deciding to add the first AI to the set of AIs as a result of determining that the determined total number of UEs exceeds the threshold.

In some embodiments, the process for producing the optimized set of AIs further comprises selecting an AI from a group of AIs comprising the second AI and a third AI, wherein the selected AI is the second AI. In some embodiments, the method further comprises, for each AI included in the group of AIs, assigning a priority to the AI, wherein selecting an AI from the group of AIs comprises selecting from the group of AIs an AI having the highest priority. In some embodiments, each AI included in the certain subset of AIs is associated with a value and a weight, and assigning a priority to the second AI comprises calculating a score using the values and weights associated with the AIs included in the certain subset of AIs. In some embodiments, calculating the score comprises: calculating V1×W1+V2×W2; and calculating W1+W2, wherein V1 is a first value associated with a first AI included in the subset of AIs, V2 is a second value associated with a second AI included in the subset of AIs, W1 is a first weight associated with the first AI included in the subset of AIs, and W2 is a second weight associated with the second AI included in the subset of AIs.

In some embodiments, the set of AIs further includes the third AI, wherein the third AI identifies a set of cells, determining that an optimized set of AIs should be created comprises determining that the second AI has a higher priority than the third AI, and the process for producing the optimized set of AIs further comprises removing the third AI from the set of AIs and adding to the set of AIs a second plurality of AIs, wherein each AI included in the second plurality of AIs identifies a subset of the cells included in the set of cells identified by the third AI.

The benefit of the above method is that it enables the first network node (e.g., BM-SC or Application Server) to activate a session (e.g., MBMS session) towards a large broadcast area while not exceeding an AI limit (e.g., the above mentioned MBMS limit of 256 SAIs) and while optimized broadcast coverage for both contents consumption concentrated in small hot spots and extremely popular contents spread over the whole region. With respect to MBMS, the optimized broadcast coverage can be achieved without extension of the MBMS session events SAI list, and this will ease the session handling for both MME and base station (e.g, eNb). With the embodiment disclosed herein, an operator will be able to deploy an effective MooD operation with the current standardized 3GPP eMBMS solution across the whole network to dynamically off load the network for both the congested small and large areas, and this will also improve the quality of service towards end users when consuming popular content.

### BRIEF DESCRIPTION OF THE DRAWINGS

The accompanying drawings, which are incorporated herein and form part of the specification, illustrate various embodiments.

FIG. 1 illustrates a system according to one embodiment.

FIG. 2 illustrates a hierarchical AI structure.

FIG. 3 is a flow chart illustrating a process according to one embodiment.

FIG. 4 illustrates a MBMS system according to one embodiment.

FIG. 5 is a flow chart illustrating a process according to one embodiment.

FIG. 6 is a message flow diagram according to one embodiment.

FIG. 7 is a block diagram of a network node according to one embodiment.

FIG. 8 is a diagram showing functional units of a network node according to one embodiment.

### DETAILED DESCRIPTION

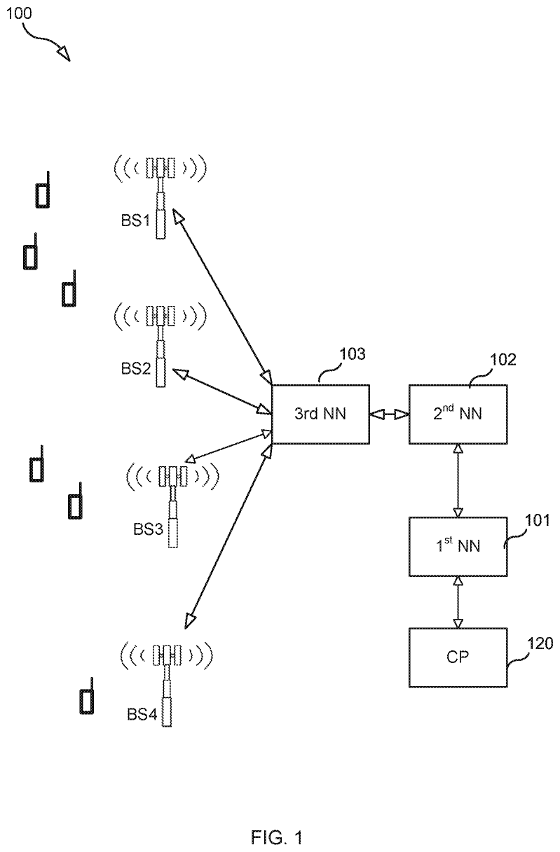

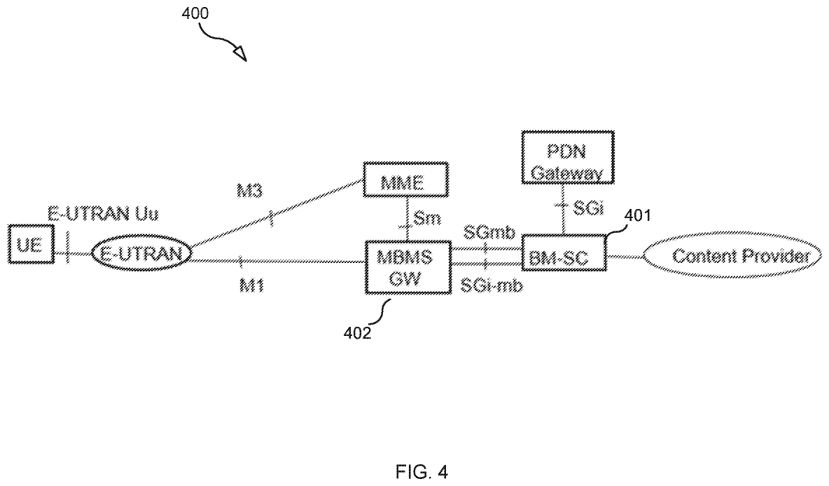

FIG. 1 illustrates a system 100 according to one embodiment. System 100 includes a content provider 120 in communication with a first network node 101 (e.g., BM-SC or application server), that communicates with a second network node 102 (e.g., a gateway such as, for example, an MBMS-GW). Second network node 103 can send control signaling (e.g., control messages) to a third network node 103 (e.g., a Mobility Management Entity (MME)). The third network node 103 is able to communicate with a group of access points (e.g., base stations, such as eNBs or other base stations). In the example shown, network node 103 is able to communicate with at least the following base stations: BS1, BS2, BS3, and BS4. In practice, network node 103 may communicate with hundreds of access points. Similarly, in some embodiments, network node 102 may also communicate with many access points via, for example, the M1 interface shown in FIG. 4.

In the example of FIG. 1, content provider 120 produces certain content that can be consumed by at least the UEs being served by BS1-BS4. First network node 101 is configured to determine the areas in which the certain content should be delivered via broadcast. More specifically, first network node 101 is configured to determine which access points should be employed to deliver the content via broadcast in a cell served by the access point. For example, based on content consumption reports transmitted by UEs and received at first network node 101, first network node 101 may determine that at least a threshold number of UEs being served by BS1 are consuming the content (or desire to consume the content). As a result of making such a determination, first network node 101 decides that BS1 should be employed to broadcast (e.g., multicast) the certain content so that each of the UEs being served by BS1 that are interested in consuming the certain content can receive the certain content via broadcast.

Once the areas are determined, first network node 101 transmits to second network node 102 a control message (e.g., a session start message, a session update message, etc.) comprising information identifying each of the determined areas, which causes network node 102 to send to network node 103 a control message comprising information identifying each of the determined areas. For example, the messages include a list of area identifiers (AIs) (e.g., a list of service area codes, wherein each code identifies an SAI). In some embodiments, each AI included in the list can be used by the third network node 103 to identify a set of one or more access points. For example, each access point can be configured with a set of AIs and each access point can send to the third network node 103 a message that includes each of the AIs with which the access point is configured. The third network node 103 can then use this information to create and store a table (or other data structure) that maps AIs to access points. Hence, when the third network node 103 receives an AI from the second network node 102, the third network node 103 can use the table to determine all of the access points that are configured with the received AI.

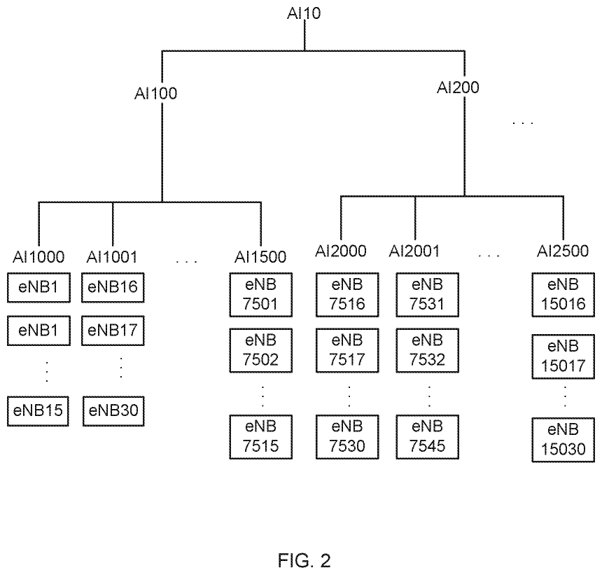

In some embodiments, as shown in FIG. 2, AIs may be hierarchically structured. That is, a group of AIs may be defined such that each AI in the group encompasses a unique set of AIs. In the example, shown, AI100 encompasses AI1000 to AI1500 and AI200 encompasses AI2000 to AI2500. As further shown, each “local” or “small” AI (i.e., AI1000 to AI1500 and AI2000 to AI2500), identifies a unique set of access points. As an example, AI1000 identifies eNB1 to eNB15 (and thereby identifies the cells served by eNB1 to eNB15) and AI1001 identifies eNB16 to eNB 30 (and thereby identifies the cells served by eNB16 to eNB30). Because AI100 encompasses AI1000 to AI1500, AI100 identifies the access points that are identified by the encompassed AIs. As further shown in FIG. 2, AI100 and AI200 may be encompassed by AI10.

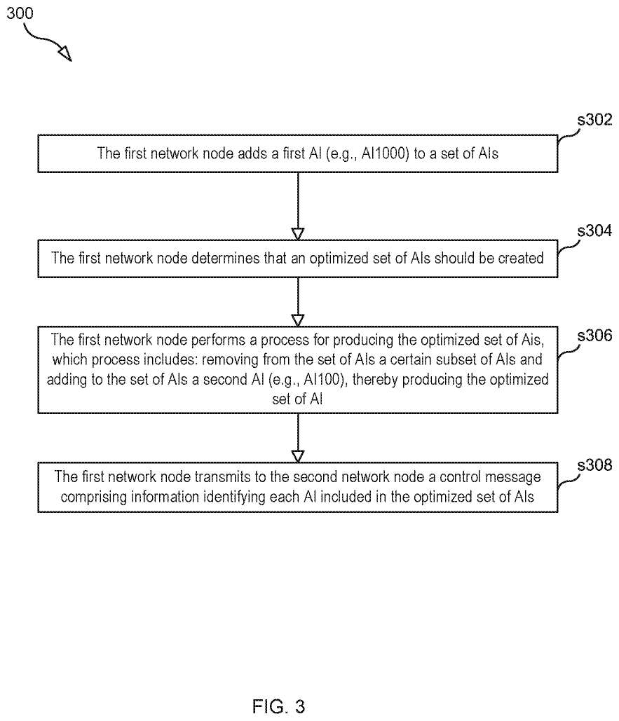

FIG. 3 is a flow chart illustrating a process 300, according to one embodiment, that is performed by first network node 101. Process 300 may begin in step s302.

In step s302, the first network node adds a first AI (e.g., AI1000) to a set of AIs. For example, the first network node may add the first AI to the set of AIs as a consequence of determining that the value X is greater than a threshold, wherein X is the number of UEs that i) are being served by an access point included in a set of access points identified by the first AI and ii) are interested in certain content.

In step s304, after adding the first AI to the set of AIs, the first network node determines that an optimized set of AIs should be created. In some embodiments, determining that an optimized set of AIs should be created comprises the first network node determining whether N is greater than T, wherein N is the number of AIs included in the set of AIs and T is a predetermined threshold (e.g., T=256).

In step s306, the first network node performs a process for producing the optimized set of AIs. The process includes: removing from the set of AIs a certain subset of AIs and adding to the set of AIs a second AI (e.g., AI100), thereby producing the optimized set of AI. Advantageously, the second AI (e.g., AI100) identifies a set of cells (e.g., the second AI is used to identify a set of one or more access points), and each one of the AIs included in the certain subset of AIs identifies a subset of the cells included in the set of cells identified by the second AI. For instance, using the AI hierarchy shown in FIG. 2, the second AI may be AI100 and the certain subset of AIs may include AI1000, AI1001, AI1002, etc. (i.e., any of the AIs encompassed by AI100). In this way, the optimized set of AIs will be smaller than the pre-optimized set of AIs.

In step s308, the first network node transmits to the second network node a control message comprising information identifying each AI included in the optimized set of AIs (e.g., a message comprising a list of MBMS service area codes).

The above process is very useful in situations in which, to reduce the amount of data that is transmitted between first network node 101 and second network node 102, a limit has been imposed on the number of AIs that can be included in the list of AIs included in the control message. For example, the limit may be 256 AIs.

In some embodiments, process 300 further includes, prior to adding the first AI to the set of AIs: the first network node determining the total number of UEs that are i) being served by a cell identified by the first AI and ii) consuming a certain item of content; the first network node determining whether the determined total number of UEs exceeds a threshold; and the first network node deciding to add the first AI to the set of AIs as a result of determining that the determined total number of UEs exceeds the threshold.

In some embodiments, the process for producing the optimized set of AIs further comprises selecting an AI from a group of AIs comprising the second AI and a third AI (e.g., AI200), wherein the selected AI is the second AI. In some embodiments, for each AI included in the group of AIs, the first network node assigned a priority to the AI, wherein selecting an AI from the group of AIs comprises selecting from the group of AIs an AI having the “highest” priority. For example, AI100 may be given a priority of P1 and AI200 may be given a priority of P2, where P1 is a “higher” priority than P2 (e.g., P1>P2 or P1<P2). In some embodiments, each AI included in the certain subset of AIs is associated with a value and a weight, and assigning a priority to the second AI comprises calculating a score using the values and weights associated with the AIs included in the certain subset of AIs. For example, if we assume that: a) the certain subset of AIs consists of AI1001 and AI10002, b) AI1001 is associated with value V1 and weight W1, and c) AI1002 is associated with value V2 and weight W2, then the first network node calculates the score for AI100 by calculating: (V1×W1+V2×W2)/(W1+W2). In some embodiments, the score calculated for AI100 is the priority value assigned to AI100. In some embodiments, the weight assigned to an AI is based on the number of access points or cells that the AI identifies.

In some embodiments, the set of AIs further includes the third AI (e.g. AI200), wherein the third AI identifies a set of cells, the step of determining that an optimized set of AIs should be created comprises determining that the second AI has a higher priority than the third AI, and the process for producing the optimized set of AIs further comprises removing the third AI from the set of AIs and adding to the set of AIs a second plurality of AIs, wherein each AI included in the second plurality of AIs identifies a subset of the cells included in the set of cells identified by the third AI.

FIG. 4 illustrates a system 400, which is a specific example of the system 100 shown in FIG. 1. System 400 includes a BM-SC 401, which corresponds to first network node 101, and also includes an MBMS-GW 402, which corresponds to second network node 102. As shown in FIG. 4, MBMS-GW 402 can communicate with an MME, which corresponds to third network node 103, via a Sm interface and can communicate with a radio access network (RAN) node (e.g., eNB) via an M1 interface. As also shown, BM-SC 401 and MBMS-GW 402 can communicate with each other via an SGmb interface and a SGi-mb interface.

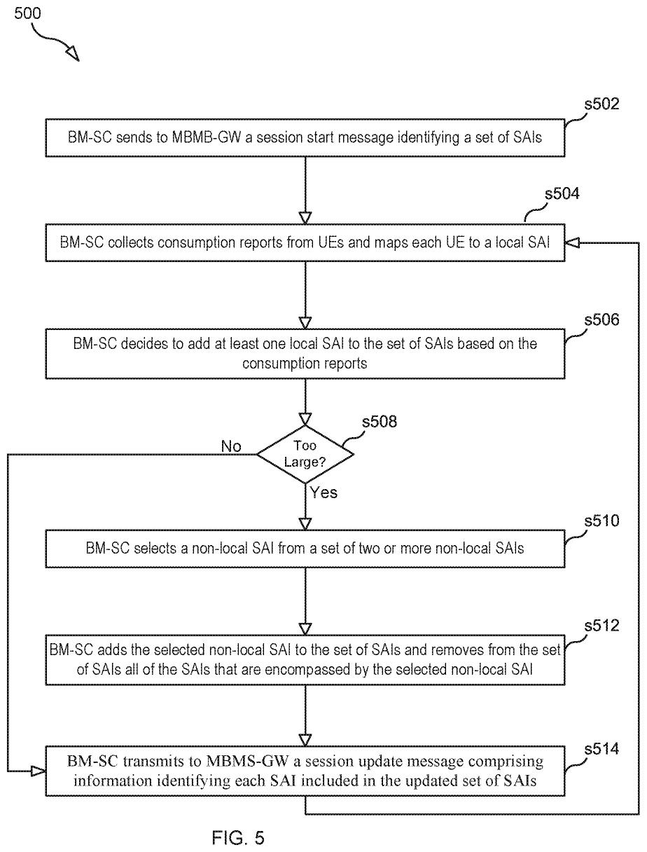

FIG. 5 illustrates a process 500, according to one embodiment, that is performed by BM-SC 401. Process 500 may begin in step s502.

In step s502, BM-SC 401 sends to MBMB-GW 402 a session start message identifying a set of SAIs (i.e., the message includes a list of service area codes).

In step s504, BM-SC 401 collects consumption reports from UEs and maps each UE to a local SAI (a “local” SAI is an SAI that does not encompass any other SAI). An example of a local SAI is AI1000 shown in FIG. 2.

In step s506, based on the consumption reports, BM-SC 401 decides to add at least one local SAI to the set of SAIs, thereby producing an updated set of SAIs.

In step s508, BM-SC 401 determines whether the set of SAIs is too large (e.g., determines whether the set contains more than 256 SAIs). If the SAI is not too large the process may proceed to step s514, otherwise the process proceeds to step 510.

In step s510, BM-SC 401 selects a non-local SAI from a set of two or more non-local SAIs. A non-local SAI is an SAI that encompasses as set of two or more local SAIs.

In step s512, BM-SC 401 adds the selected non-local SAI to the set of SAIs and removes from the set of SAIs all of the SAIs that are encompassed by the selected non-local SAI. In some embodiments, if, after removing the local SAIs from the set, the number of SAIs in the set is less than 256 (e.g., less than 200) then BM-SC 401 may determine whether there exists in the set of SAIs a non-local SAI that can be removed from the set. A non-local SAI can be removed from the set if the number of local SAIs encompassed by the non-local SAI that would need to be added to the set if the non-local SAI was removed is less than or equal to a threshold, where the threshold is defined as 257-N, were N is the number of SAIs included in the set after step s512 is performed. Assuming such a non-local SAI exists, then BM-SC 401 may remove the non-local SAI from the set and add to the set each local SAI that is encompassed by the non-local SAI and that needs to be added to the set (a local SAI that is encompassed by the non-local SAI needs to be added to the set when the number of interested UEs located in the area encompassed by the local SAI exceeds a certain threshold). In this way, the updated set of SAIs is optimized.

In step s514, BM-SC 401 transmits to MBMS-GW 402 a session update message comprising information identifying each SAI included in the updated, optimized set of SAIs. After step s514, the process may go back to step s504.

With respect to step s510, in one embodiment, BM-SC 401 selects a non-local SAI from the set of two or more non-local SAIs by calculating a score (or “average UE ratio”) for each non-local SAI included in the set of non-local SAIs. The average UE ratio for a non-local SAI is calculated based on the UE ratio for each local SAI that is encompassed by the non-local SAI. For example, assume SAI100 encompasses the following local SAIs: SAI1000 to SAI1020, then the average UE ratio for SAI100 can be calculated as: ((SAI1000−UE-Ratio×SAI1000−weight)+ . . . +(SAI1020−UE-Ratio×SAI1020−weight))/(SAI1000−weight+ . . . +SAI1020−weight). The UE ratio for a local SAI can be simply defined as 1 for area reaching the defined UE threshold, i.e. broadcast need to be activated in the area, and 0 for area not reaching the defined UE threshold, i.e. broadcast is not needed in the area. This is more suitable when the local areas have similar size. More complex UE ratio can also be used to have more fine grained optimization. For example, the UE ratio for a local SAI can be defined as the number of interested UEs in the local area divided by the number of cells in the local area. The weight assigned to a local SAI can be defined as 1, if the local areas have similar size, otherwise the weight can be defined based on the number of the cells in the area in order to have a more accurate radio resource utilization comparison between different areas.

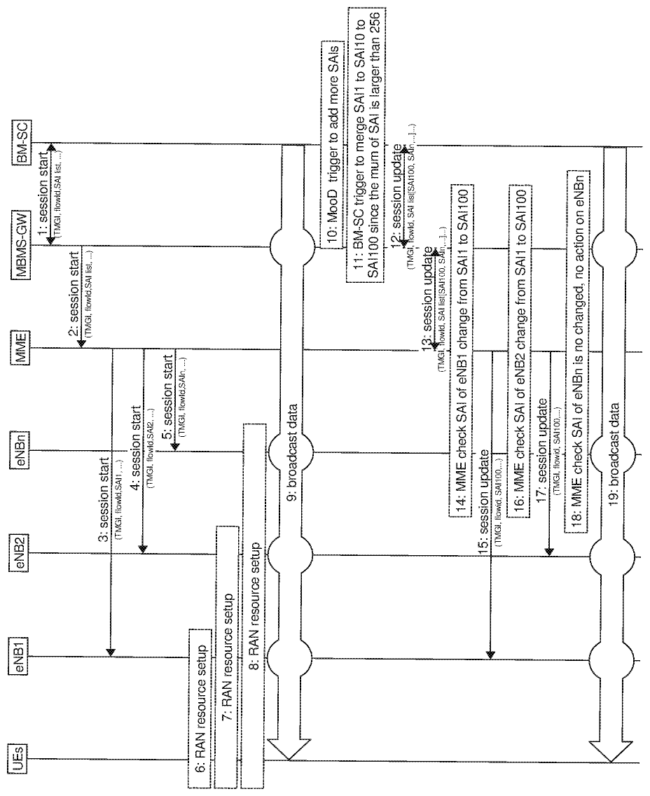

FIG. 6 is a message flow diagram illustrating steps that are performed by the various network nodes shown in FIG. 4. More specifically, FIG. 6 illustrates the SAI aggregation sequence flow when MooD service is enabled to trigger more SAIs to support broadcast for the E2E system.

Step 1: BM-SC sends the session start request (e.g. Temporary Mobile Group Identity (TMGI), flow, SAI list and other parameters) to MBMS-GW, MBMS-GW assign the resources for the session and then sends a session start success response back to BM-SC.

Step 2: MBMS-GW send the session start request (TMGI, flow, SAI list and other parameters) to an MME to start the session. The MME may send back to MBMS-GW a session start response (not shown in the figure) as soon as the session request is accepted to by a RAN node.

Step 3: MME sends the session start request (TMGI, SAI1 and other parameters) to eNB1, eNB1 assigns the RAN resource and send the session start success response back to MME.

Step 4: MMEs send the session start request (TMGI, SAI2 and other parameters) to eNB2, eNB2 assigns the RAN resource and send the session start success response back to MME.

Step 5: MME send the session start request (TMGI, SAIn and other parameters) to eNBn, eNBn assigns the RAN resource and send the session start success response back to MME.

Steps 6.7.8: eNBs establishes the necessary radio resources for the transfer of MBMS data to the interested UEs.

Step 9: The BM-SC starts sending the MBMS data, all relevant eNBs receiver IP Multicast distribution data and broadcast/multicast to the interested UEs.

Step 10: BM-SC would like to offload traffic in a new traffic area since the traffic volume in this area exceeds a certain threshold. For example, as described above, BM-SC may receive consumption reports from UEs and based on the consumption reports the BM-SC may determine that at least a threshold number of UEs that are mapped to a local SAI are consuming the MBMS data. As a result of this determination, the BM-SC adds the local SAI to the SAI list.

Step 11: BM-SC detects that the number of SAIs in the SAI list exceed the 256 due to more SAIs are added into the broadcast area. Accordingly, BM-SC decides to replace a set of local SAIs with a non-local SAI. More specifically, as described above with respect to steps s512, BM-SC removes from the list of SAIs all of the local SAIs that are encompassed by the non-local SAI.

Step 12: BM-SC send the session update request to MBMS-GW with the new SAI list.

Step 13: MBMS-GW sends the session update request to the impacted MMEs.

Step 14: MME detects that the SAI of eNB1 is changed from local SAI1000 to the reginal SAI100.

Step 15: MME send the session update with SAI100 to the eNB1.

Step 16: MME detects that the SAI of eNB2 is changed from local SAI1002 to the reginal SAI100.

Step 17: MME send the session update with SAI100 to the eNB2.

Step 18: MME detects that the SAI of eNBn is not changed, no extra action is needed for eNBn.

Step 19: all relevant eNBs continues to accept IP Multicast distribution data and broadcast to the interested UEs.

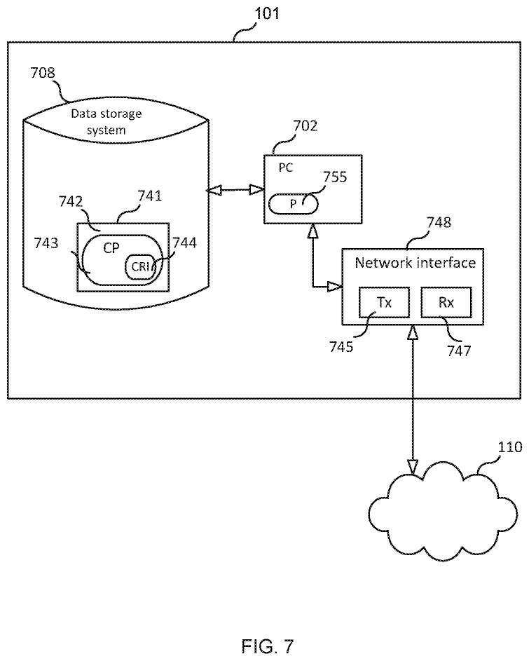

FIG. 7 is a block diagram of network node 101, according to some embodiments. As shown in FIG. 7, network node 101 may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like); a network interface 748 comprising a transmitter (Tx) 745 and a receiver (Rx) 747 for enabling network node 101 to transmit data to and receive data from other nodes connected to a network 110 (e.g., an Internet Protocol (IP) network) to which network interface 748 is connected; and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes network node 101 to perform steps described herein (e.g., steps described herein with reference to the flow charts). In other embodiments, network node 101 may be configured to perform steps described herein without the need for code. That is, for example, PC 702 may consist merely of one or more ASICs. Hence, the features of the embodiments described herein may be implemented in hardware and/or software.

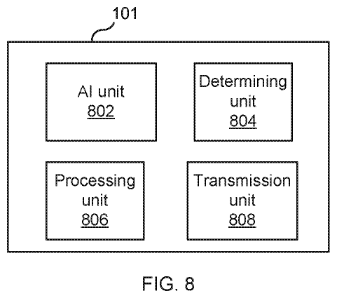

FIG. 8 is a diagram showing functional units of network node 101 according to one embodiment. In the embodiment shown, network node 101 includes: a transmission unit 802; a receiver unit 804; and a processing unit 806.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method, performed by a first network node, for delivering content, the method comprising:
the first network node adding a first area identifier, AI, to a set of AIs;
after adding the first AI to the set of AIs, the first network node determining that an optimized set of AIs should be created;
the first network node performing a process for producing the optimized set of AIs, the process comprising: removing from the set of AIs a certain subset of AIs and adding to the set of AIs a second AI, the second AI identifying a set of cells, wherein each one of the AIs included in the certain subset of AIs identifies a subset of the cells included in the set of cells identified by the second AI; and
the first network node transmitting to a second network node a message comprising information identifying each AI included in the optimized set of AIs.

2. The method of claim 1, wherein determining that an optimized set of AIs should be created comprises the first network node determining whether N is greater than T, wherein N is the number of AIs included in the set of AIs and T is a predetermined threshold.

3. The method of claim 1, further comprising, prior to adding the first AI to the set of AIs:
the first network node determining the total number of user equipments, UEs, that are i) being served by a cell identified by the first AI and ii) consuming or preparing to consume a certain item of content;
the first network node determining whether the determined total number of UEs exceeds a threshold; and
the first network node deciding to add the first AI to the set of AIs as a result of determining that the determined total number of UEs exceeds the threshold.

4. The method of claim 1, wherein the process for producing the optimized set of AIs further comprises selecting an AI from a group of AIs comprising the second AI and a third AI, wherein the selected AI is the second AI.

5. The method of claim 4, further comprising:
for each AI included in the group of AIs, assigning a priority to the AI, wherein
selecting an AI from the group of AIs comprises selecting from the group of AIs an AI having the highest priority.

6. The method of claim 5, wherein
each AI included in the certain subset of AIs is associated with a value and a weight, and
assigning a priority to the second AI comprises calculating a score using the values and weights associated with the AIs included in the certain subset of AIs.

7. The method of claim 6, wherein calculating the score comprises:
calculating V1×W1+V2×W2; and
calculating W1+W2, wherein
V1 is a first value associated with a first AI included in the subset of AIs,
V2 is a second value associated with a second AI included in the subset of AIs,
W1 is a first weight associated with the first AI included in the subset of AIs, and
W2 is a second weight associated with the second AI included in the subset of AIs.

8. The method of claim 4, wherein
the set of AIs further includes the third AI, wherein the third AI identifies a set of cells,
determining that an optimized set of AIs should be created comprises determining that the second AI has a higher priority than the third AI, and
the process for producing the optimized set of AIs further comprises removing the third AI from the set of AIs and adding to the set of AIs a second plurality of AIs, wherein each AI included in the second plurality of AIs identifies a subset of the cells included in the set of cells identified by the third AI.

9. The method of claim 1, wherein
the first network node is a 3GPP Broadcast Multicast Service Center (BM-SC), and
the second network node is a 3GPP MBMS-GW.

10. The method of claim 9, wherein the message is one of: a session start message and a session update message.

11. A first network node for delivering content, the first network node comprising:
a processor, and
a memory device coupled to the processor and having instructions stored therein that are executable by the processor to cause the first network node to:
add a first area identifier, AI, to a set of AIs;
after adding the first AI to the set of AIs, determine that an optimized set of AIs should be created;
perform a process for producing the optimized set of AIs, the process comprising: removing from the set of AIs a certain subset of AIs and adding to the set of AIs a second AI, the second AI identifying a set of cells, wherein each one of the AIs included in the certain subset of AIs identifies a subset of the cells included in the set of cells identified by the second AI; and
transmit to a second network node a message comprising information identifying each AI included in the optimized set of AIs.

12. The first network node of claim 11, wherein determining that an optimized set of AIs should be created comprises the first network node determining whether N is greater than T, wherein N is the number of AIs included in the set of AIs and T is a predetermined threshold.

13. The first network node of claim 11, wherein the instructions are further executable by the processor to cause the first network node to, prior to adding the first AI to the set of AIs:
determine the total number of user equipments, UEs, that are i) being served by a cell identified by the first AI and ii) consuming or preparing to consume a certain item of content;
determine whether the determined total number of UEs exceeds a threshold; and
decide to add the first AI to the set of AIs as a result of determining that the determined total number of UEs exceeds the threshold.

14. The first network node of claim 11, wherein the instructions are further executable by the processor to cause the process for producing the optimized set of AIs further to select an AI from a group of AIs comprising the second AI and a third AI, wherein the selected AI is the second AI.

15. The first network node of claim 14, wherein the instructions are further executable by the processor to cause the first network node to:
for each AI included in the group of AIs, assign a priority to the AI, wherein
selecting an AI from the group of AIs comprises selecting from the group of AIs an AI having the highest priority.

16. The first network node of claim 15, wherein
each AI included in the certain subset of AIs is associated with a value and a weight, and
assigning a priority to the second AI comprises calculating a score using the values and weights associated with the AIs included in the certain subset of AIs.

17. The first network node of claim 16, wherein calculating the score comprises:
calculating V1×W1+V2×W2; and
calculating W1+W2, wherein
V1 is a first value associated with a first AI included in the subset of AIs,
V2 is a second value associated with a second AI included in the subset of AIs,
W1 is a first weight associated with the first AI included in the subset of AIs, and
W2 is a second weight associated with the second AI included in the subset of AIs.

18. The first network node of claim 14, wherein
the set of AIs further includes the third AI, wherein the third AI identifies a set of cells,
determining that an optimized set of AIs should be created comprises determining that the second AI has a higher priority than the third AI, and
the process for producing the optimized set of AIs further comprises removing the third AI from the set of AIs and adding to the set of AIs a second plurality of AIs, wherein each AI included in the second plurality of AIs identifies a subset of the cells included in the set of cells identified by the third AI.

19. The first network node of claim 11, wherein
the first network node is a 3GPP Broadcast Multicast Service Center (BM-SC), and
the second network node is a 3GPP MBMS-GW.

20. (canceled)

21. A computer program, comprising instructions which, when executed by a first network node, cause the first network node to carry out the method of claim 1.

22. A carrier containing the computer program of claim 21, wherein the carrier is one of an electronic signal, optical signal, radio signal, and computer readable storage medium.
